(19) United States
(12) Patent Application Publication
(10) Pub. No.: US 2008/0230172 A1
(43) Pub. Date: Sep. 25, 2008

(54) Fixing kit and method for fixing a stem in a holder by means of adhesive

(75) Inventor: Jean Baebler, Fribourg (CH)

Correspondence Address: Davidson, Davidson & Kappel, LLC, 485 7th Avenue, 14th Floor, New York, NY, 10018, US

(73) Assignee: Saphirwerk Industrieprodukte AG, Bruegg (CH)

(21) Appl. No.: 11/825,762

(22) Filed: Jul. 9, 2007

(30) Foreign Application Priority Data
Jul. 19, 2006 (DE) DE 102006033442.6

(51) Int. Cl. B29C 65/52; F16B 13/14

(52) U.S. Cl. 156/157; 411/82

(57) ABSTRACT

The present invention provides a kit for fixing a stem in a holder of a measurement apparatus, wherein the kit comprises a holder, which has a bore, and a stem, with a first end and a second end, wherein the bore has at least one vertical groove. The present invention furthermore provides a method for fixing a stem in the holder by means of adhesive.

This claims the benefit of German Patent Application No. 10 2006 033 442.6, filed on Jul. 19, 2006, and hereby incorporated by reference herein.

The present invention relates to a fixing kit and to a method for fixing a stem of a cylindrical component in a holder using an adhesive.

### BACKGROUND

Today, manufacturing or measuring process sequences are becoming ever more automated and simplified.

For example, if two workpieces are to be firmly and reliably connected to each other, the state of the art offers possible methods using gluing, compression, welding, soldering, etc.

However, the disadvantage of the solutions cited in the state of the art is that the life of the materials can be adversely affected by the connection.

### SUMMARY OF THE INVENTION

It is an object of the present invention, with such types of connection, to increase the life of the materials involved in the connection having regard to the brittleness and strength of the different materials and thus to minimize the economic costs.

The present invention provides a kit for fixing a stem in a kit (100) for fixing a stem (3) in a holder (10) is provided, wherein the kit (100) includes a holder (10), which has a bore (1), and a stem (3), with a first end (E1) and a second end (E2), wherein the bore (1) has at least one recess (G, R) in a predefined area of the bore (1).

By a kit is meant a set of individual parts, here a stem and a holder, which together comprise a complete unit.

By fixing is meant that a stem is attached in the holder such that it is connected in stable manner, preferably firmly and for long periods, to same. Naturally it is equally possible that the fixing lasts only for a specific period of time, for example for the duration of a measurement.

By a stem is meant preferably a piston, a cylinder, a stylus, a pin etc. Such a stem is preferably a cylindrical component made of materials such as hard metal, ceramic (used as a generic term covering, say, nitrides, oxides, carbides, borides, ferrites, silicides and their compounds in polycrystalline and monocrystalline structure), fibre-reinforced plastic, etc.

The holder serves to create a secure connection to the stem. It preferably has a recess in the form of a bore which extends a specific distance down into the holder in order to insert the stem into the holder by a predefined length, preferably 1-50% of the total length of the stem.

There is a bore in the holder. It can have a predefined, application-specific shape and is attached in the holder by means of a suitable tool, preferably a drill bit. In addition, the bore preferably has a recess which is located in a predefined area of the casing surface of the bore. The advantage offered by the recess according to the invention, which can have the most varied shapes, such as a thread or screw thread, internal thread, groove, etc., and the course of which can likewise be formed as desired on the casing surface of the bore, is that with the method according to the invention described below, an adhesive can be distributed evenly or uniformly between the inserted stem and the casing surface of the bore.

The bore preferably has a cylindrical shape in an upper area, whereas in a lower area, a reservoir area which is usually located furthermost from the opening of the bore, the bore is preferably conical. If there is a thread inside the bore, this preferably runs to the upper opening of the bore.

The stem has both a first end and a second end. The first end is furthermost from the second end and is at its greatest distance from the bore of the holder after the stem has been inserted into the holder.

The first end is the end at which a force F is applied with the method according to the invention, presented below. The second end is the end of the stem which is inserted into the bore.

It is preferred according to a further aspect of the present invention that the recess includes at least one thread in a predefined area of the bore. The thread is preferably a screw thread, in particular an internal thread, which is preferably a buttress thread, round thread or flat thread. It is preferred that the thread is arranged only in a predefined area of the bore or extends over the whole surface of the bore. The thread preferably runs from the edge of the bore into the reservoir area in order to make possible a later throughflow of adhesive from the reservoir area over the thread. The course of the thread is preferably helical or helix-shaped with a specific thread pitch which is preferably formed evenly over the casing surface of the bore, but can also follow a different course along the casing surface of the bore. The feature of a formation of the thread in a predefined area results in the advantage that the strength of the fixing of the stem in the holder can be optimized in an application-specific way.

### Intention Intension

It is preferred according to a further aspect of the present invention that an internal diameter d of the bore (G) is sized relative to an external diameter D of the stem (3) such that a form-locking hold forms between the bore and the stem (3). By internal diameter is meant the distance from a point on the surface of the bore to the closest, exactly opposite point on the other side of the bore.

By external diameter of the stem is meant the diameter that is obtained when the stem is measured for example with a sliding calliper or a vernier calliper.

As the internal diameter d of the bore can be smaller than the external diameter of the stem, wherein the difference is in the percentage range, preferably 0.1 to 5%, a so-called form-locking hold forms between the bore and the stem, which is preferably used when an adhesive is used later to fix the stem in the bore, as the stem holds fast in the bore during the setting of the adhesive and need not be held from outside or externally.

It is preferred according to a further aspect of the present invention that the recess in the bore has at least one groove.

Moreover, the bore of the holder may have at least one groove. This preferably runs from the upper edge, which is located at the opening of the bore, over a certain, predefined length into the bore in the direction of the reservoir area. It is thereby guaranteed that in the further course of the method according to the invention adhesive can travel from the reservoir area via the grooves to the edge of the bore.

The length of the at least one groove R or a plurality of grooves R can be different from one another. The grooves R are preferably the same length and the grooves in the inside surface of the bores are spaced evenly apart.

Moreover, it is preferred that the groove or the grooves in the bore have a recess which is comparable with a depth profiling of a possible thread. However, the depth of the grooves can also be larger or smaller than the depth profiling of a possible thread.

It is preferred according to a further aspect of the present invention that the recess in the bore has at least one vertical groove. Because of the vertical course of the groove, the shape and course of which are preferably like that of the groove described above, there is a further stabilizing of a stem glued according to the invention in the holder.

It is preferred according to a further aspect of the present invention that the bore (1) has a conical cavity (K) in its lower area or reservoir area. The conical cavity can be produced with a specific drill bit and has the advantage that, after the stem is inserted into the bore of the holder, the second end of the stem does not touch the base of the bore, there thus remains in the lower end of the bore an air gap which in the further course of the method according to the invention serves to accommodate sufficient adhesive in the bore and distribute it evenly in the bore, the thread and vertical grooves of the bore during the method according to the invention.

It is preferred according to a further aspect of the present invention that the stem has a cylindrical shape and the second end (E2) is formed frustrum-shaped. The cylindrical shape of the stem has the advantage that it can be inserted easily into the bore of the holder. The effect of the frustrum-shaped appearance of the stem is that, as already mentioned above, after the complete insertion of the stem into the bore, an air gap remains between the second end and the base of the bore which later serves as a possible reservoir for the adhesive.

The present invention also provides a method for fixing a stem (3) in a holder (10), wherein the method includes the following steps:
introduction of a predefined quantity of an adhesive (2) into a bore (1) of a holder (10);
insertion of a second end (E2) of the stem (3) into the bore (1) with a predefined force (F).

By the step of introducing a predefined quantity of an adhesive into a bore of a holder is meant that a user introduces a specific quantity of adhesive manually or by automated means into the bore of the holder. The adhesive can preferably be introduced in liquid form or also in the form of adhesive capsules which later burst after insertion of the stem, as they touch the stem in passing because of their geometry.

The adhesive is preferably a plastic adhesive, an epoxy resin or hot solder and metal which is introduced into the bore. The adhesive preferably represents an appropriate reliable connection between materials with different material properties, which affects the later properties of a stylus which is composed of a stem in a bore.

By the step of inserting a second end (E2) of the stem (3) into the bore (1) with a predefined force (F) is meant that after the adhesive is introduced the user inserts the stem manually or by automatic means into the bore, during which a predefined specific force is exerted on the stem. Through the insertion of the stem into the bore, the adhesive is distributed over the recess, for example the adhesive travels via grooves from the reservoir area over the casing surface of the bore to the outside area of the holder.

At the same time, so much adhesive is introduced into the bore that firstly the second end, later a further surface area of the stem, touch the adhesive which is increasingly expelled from the conical recess of the bore, due to the exerted force F. The quantity of plastic preferably corresponds to the difference in volume between the volume of the bore and the possible volume of the stem which can be accommodated in the bore. In this case, the adhesive would extend to the upper edge of the bore and would thus fully seal all the threaded bores and grooves.

It is preferred according to a further aspect of the present invention that the direction of the force (F) applied to the second end (E2) of the stem (3) runs parallel to the longitudinal axis of the stem (3). The advantage thereby results that the stem does not tilt with the bore of the holder and runs perpendicular to the plane of the bore opening, whereby the accuracy of the measurements carried out later is increased.

It is preferred according to a further aspect of the present invention that the force (F) is exerted at the first end (E1) of the stem (S). The advantage thereby results that there is an optimum transmission of force via the stem to the reservoir area with the adhesive and the adhesive is distributed accordingly in the bore.

Method according to the previous method claims, wherein the force (F) is exerted with an external device (E). An external device is preferably an automated device which exerts a predefined force on the stem. The advantage thereby results that the attachment of the stem by means of adhesive in the holder can be automated and simplified and thus the method saves on time and costs.

It is preferred according to a further aspect of the present invention that the external device (E) allows a force (F) to be exerted on the stem (3) until the adhesive (2) has set. The advantage thereby results that after the stem is released by the external device, the stem can no longer be moved and pushed and thus, as already mentioned, runs perpendicular to the plane of the bore opening.

It is preferred according to a further aspect of the present invention that the adhesive comes from the group which includes: cyanoacrylate adhesive, methyl methacrylate adhesive, anaerobically setting adhesive, unsaturated polyesters (UP resins), radiation-setting adhesive, polycondensation adhesive, phenolformaldehyde adhesive, silicone adhesive, silane-crosslinking polymer adhesive, polyimide adhesive, polyaddition adhesive, epoxide adhesive, polyurethane adhesive, polymerization adhesive, contact-bonding adhesive, hot-melt adhesive, solvent-containing adhesive, wet adhesive, contact adhesive, dispersion adhesive, water-based adhesive, plastisol, plastic adhesive, epoxy resin, hot solder, adhesion adhesive. It is preferred that at least one adhesive of the abovenamed adhesives or a combination of these adhesives is introduced into the bore. Likewise it is possible that the adhesive is introduced into the bore in the form of a capsule and this capsule bursts after the stem is inserted and the adhesive is subsequently distributed evenly in the bore of the holder.

It is further preferred that by the adhesive can be meant a material or a product which joins together corresponding workpieces, i.e. stem and bore of the holding device, and also the thread or groove arranged therein, i.e. the adhesive represents a corresponding connection between the surfaces of the workpieces to be joined together. As already mentioned above, the adhesive need not be an adhesive in the conventional sense, such as for example a plastic-based adhesive, but hot solder and metal can preferably also be used which, due to its composition, creates a corresponding reliable and solid connection between the stem and the holding device.

Moreover, it is preferred that the adhesive is set, particularly preferably thermally set, by means of suitable devices in order to accelerate the setting process of the adhesive.

Preferred embodiments of the invention are explained in more detail below with reference to the attached drawing.

### BRIEF DESCRIPTION OF THE DRAWINGS

FIG. 1 shows the sequence of the method steps (S1 to S3) for fixing a stem in a holder.

FIG. 2 shows a detail view of the adhesive distributed in the bore and attached stem.

### DETAILED DESCRIPTION

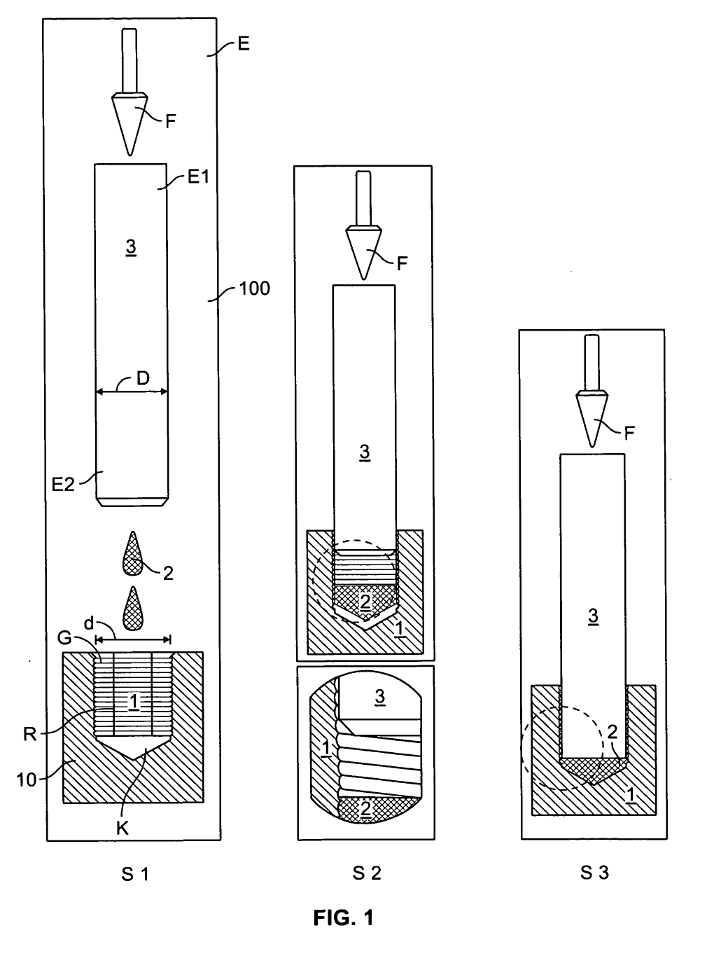

FIG. 1 shows a kit 100 for fixing a stem 3 made of expanded metal in a bore 1 of a high-grade steel holder 10 using an adhesive 2.

It is shown in the first step S1 of FIG. 1 that an adhesive 2, in the embodiment example an instant glue with the chemical compound cyanoacrylate, is first introduced dropwise into the bore 1. A quantity of 10 ml is used.

The bore 1 has a capacity of 100 ml and in its upper area is formed cylindrical with an internal thread G in the form of a round thread. The internal thread travels along the casing surface of the bore 1 from the edge of the bore into the lower area or reservoir area of the bore which has a conical cavity K. The thread has an evenly distributed helical thread pitch. It can be seen that the thread G is formed only in the left-hand part of the bore of FIG. 1, while no profiling by the thread can be seen in the right-hand part of bore 1.

Moreover, the bore has eight vertical grooves R, wherein here in FIG. 1 only two vertical grooves R are shown. The grooves are 25 mm long and 0.5 mm deep.

The cylindrical stem 3 is 100 mm long and 15 mm wide. The stem is frustrum-shaped at its second end E2.

Moreover, it is shown in the first step S1 of FIG. 1 that a force F is exerted parallel to the longitudinal axis of the stem 3 in the direction of the bore 1 by means of an external device E, an automated device in the form of a robot.

It is shown in the second step S2 of the method how the stem 3 is inserted continuously with the force F at a certain rate into the bore 1. The stem 1 has not yet touched the adhesive 2 which is distributed in the reservoir area and thus not yet expelled it. The fill level of the adhesive extends in this embodiment example to the third thread turn, with the result that the lower part of the conical section of the bore is also completely covered with adhesive.

A detail view, shown circled in the upper diagram of the second step S2, is also shown in the lower diagram of S2. The frustrum shape of the second end E2 of the stem 3, the course of the thread along the casing surface of bore 1, and also the fill level of the adhesive 2 can be seen.

Finally, it is shown in the third step S3 of FIG. 1 that the stem 3 has been inserted gradually into the bore 1 of the holder and has thus expelled the adhesive fully into the thread turns of the internal thread and into the grooves, not shown here. In this step, the force F continues to be exerted by the external device E until the adhesive 2 has set, then the external device is moved away from the stem (not shown) and a new stem 3 can be fixed in a further holder 10.

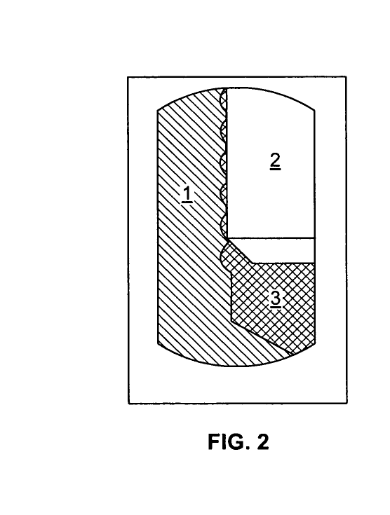

A detail view shown circled in the third step S3 in FIG. 1 is shown in FIG. 2.

It can be seen clearly in FIG. 2 that the adhesive fills the left-hand side thread turns of the bore and also the vertical grooves (not shown here). The adhesive runs helical via the reservoir area along the thread turns at the second frustrum-shaped end E2 along the thread turns until it reaches the surface of the holder, the intermediate space between the bore and the stem is completely and evenly distributed, also impeding or preventing the continued presence in the adhesive of gas or air bubbles which could later influence the stability of the adhesive compound after the adhesive sets.

The result of this complete filling of the intermediate space in this embodiment example, i.e. of the left-hand thread turns and the vertical grooves, with adhesive 2 is that the lower portion of the stem 3 with the second end E2 is completely surrounded by adhesive which subsequently sets and closely surrounds the lower portion of the stem 3 and stabilizes it in the holder.

The device according to the invention and also the method according to the invention thus result in the advantage that a stem, for example made of porous material, can be fixed easily and at favorable cost with a bore of a holder and the accuracy of a measurement apparatus which contains a stem fixed in this way is thereby increased.

What is claimed is:

1. A kit for fixing a stem using adhesive in a holder of a measurement apparatus, comprising:
a holder having a bore, and
a stem having a first end and a second end, the second end insertable into the bore, and wherein the bore has at least one recess in a predefined area of the bore.

2. The kit according to claim 1 wherein the recess has at least one thread.

3. The kit according to claim 1 wherein the recess has at least one groove.

4. The kit according to claim 3 wherein the groove runs vertically.

5. The kit according to claim 1 wherein the bore has a reservoir area with a conical cavity.

6. The kit according to claim 1 wherein the stem has a cylindrical shape and its second end is frustrum-shaped.

7. A method for fixing a stem in a holder, the stem having a first end and a second end in a holder, the method comprising the following steps:
introduction of a predefined quantity of an adhesive into a bore of a holder; and
insertion of a second end of the stem into the bore with a predefined force.

8. The method according to claim 7 wherein the force is exerted on the first end of the stem.

9. The method according to claim 7 wherein the force is exerted by an external device.

10. The method according to claim 7 wherein the direction of the force applied to the first end of the stem runs parallel to the longitudinal axis of the stem.

11. The method according to claim 7 wherein the force is exerted until the adhesive has set.

12. The method according to claim 7 wherein the adhesive comes from the group which comprises: cyanoacrylate adhesive, methyl methacrylate adhesive, anaerobically setting adhesive, unsaturated polyesters (UP resins), radiation-setting adhesive, polycondensation adhesive, phenolformaldehyde adhesive, silicone adhesive, silane-crosslinking polymer adhesive, polyimide adhesive, polyaddition adhesive, epoxide adhesive, polyurethane adhesive, polymerization adhesive, contact-bonding adhesive, hot-melt adhesive, solvent-containing adhesive, wet adhesive, contact adhesive, dispersion adhesive, water-based adhesive, plastisol, adhesion adhesive, plastic adhesive, polymer adhesive, hot solder, epoxy resin or a combination of these adhesives.
